(19) United States
(12) Patent Application Publication
(10) Pub. No.: US 2021/0378033 A1
(43) Pub. Date: Dec. 2, 2021

(54) INFORMATION PROCESSING APPARATUS, INFORMATION PROCESSING METHOD, AND NON-TRANSITORY COMPUTER-READABLE RECORDING MEDIUM

(71) Applicant: NEC Corporation, Tokyo (JP)

(72) Inventor: Takatoshi OGAWA, Tokyo (JP)

(73) Assignee: NEC Corporation, Tokyo (JP)

(21) Appl. No.: 17/326,543

(22) Filed: May 21, 2021

(30) Foreign Application Priority Data
Jun. 2, 2020 (JP) 2020-096176

(51) Int. Cl. H04W 76/10; H04W 72/04; H04W 4/02; H04W 48/02; H04W 48/20

(52) U.S. Cl. CPC H04W 76/10; H04W 72/048; H04W 48/20; H04W 48/02; H04W 4/02

(57) ABSTRACT

An information processing apparatus includes position information acquisition means that acquires position information; configuration information identification means that identifies, from management information in which position information is associated with configuration information for configuring a wireless transmission apparatus, one or more items of configuration information corresponding to the position information acquired by the position information acquisition means; reception means that, in a case in which two or more items of the configuration information corresponding to the position information are identified by the configuration information identification means, receives a user input for selecting one of the two or more items of configuration information that have been identified; and determination means that determines the configuration information to be used to configure the wireless transmission apparatus on the basis of the user input that has been received.

### CROSS-REFERENCE TO RELATED APPLICATIONS

This application is based upon and claims the benefit of priority Japanese Patent Application No. 2020-096176, filed Jun. 2, 2020, the disclosure of which is incorporated herein in its entirety by reference.

### TECHNICAL FIELD

The present invention relates to an information processing apparatus, an information processing method, and a non-transitory computer-readable recording medium.

### BACKGROUND ART

Japanese Unexamined Patent Application, First Publication No. 2010-283638 (hereinafter referred to as “Patent Document 1”) discloses technology in which a control apparatus configures a base station apparatus by acquiring, from a memory, parameters corresponding to position information and type information of the base station apparatus and transmitting the parameters to the base station apparatus.

In this way, Patent Document 1 discloses technology in which a control apparatus configures a wireless transmission apparatus by acquiring, from a memory, configuration information corresponding to position information and type information of the wireless transmission apparatus. However, if the above-mentioned technology is used when multiple wireless transmission apparatuses are associated with the same type information and the same position information, then multiple wireless transmission apparatuses will be configured in the same way, and configuration errors may occur. Additionally, the above-mentioned technology cannot be used if the configuration information is not managed by being linked to type information, and configuration errors may occur in the wireless transmission apparatus.

### SUMMARY

An example object of the present invention is to provide an information processing apparatus, an information processing method, and a non-transitory computer-readable recording medium that solve the above-mentioned problems.

The information processing apparatus according to an example aspect of the present invention includes: a memory configured to store instructions, and a processor configured to execute the instructions to acquire position information; identify, from management information in which position information is associated with configuration information for configuring a wireless transmission apparatus, one or more items of configuration information corresponding to the acquired position information; in a case in which two or more items of the configuration information corresponding to the position information are identified, receive a user input for selecting one of the two or more items of configuration information that have been identified; and determine the configuration information to be used to configure the wireless transmission apparatus on the basis of the user input that has been received.

The information processing method according to an example aspect of the present invention includes: acquiring position information; identifying, from management information in which position information is associated with configuration information for configuring a wireless transmission apparatus, one or more items of configuration information corresponding to the acquired position information; in a case in which two or more items of the configuration information corresponding to the position information are identified, receiving a user input for selecting one of the two or more items of configuration information that have been identified; and determining the configuration information to be used to configure the wireless transmission apparatus on the basis of the user input that has been received.

The non-transitory computer-readable recording medium according to an example aspect of the present invention records a program for making a computer perform: acquiring position information; identifying, from management information in which position information is associated with configuration information for configuring a wireless transmission apparatus, one or more items of configuration information corresponding to the acquired position information; in a case in which two or more items of the configuration information corresponding to the position information are identified, receiving a user input for selecting one of the two or more items of configuration information that have been identified; and determining the configuration information to be used to configure the wireless transmission apparatus on the basis of the user input that has been received.

According to at least one example aspect among the abovementioned example aspects, configuration errors in wireless transmission apparatuses can be prevented.

### BRIEF DESCRIPTION OF THE DRAWINGS

FIG. 1 is a diagram illustrating the structure of an information processing system according to a first example embodiment.

FIG. 2 is a schematic block diagram illustrating the structure of a control terminal according to the first example embodiment.

FIG. 3 is a flow chart illustrating the operations performed by the information processing system according to the first example embodiment.

FIG. 4 is a diagram illustrating the structure of an information processing system according to a second example embodiment. FIG. 5 is a schematic block diagram illustrating the structure of a control terminal according to the second example embodiment.

FIG. 6 is a flow chart illustrating the operations performed by the information processing system according to the second example embodiment.

FIG. 7 is a schematic block diagram illustrating the structure of a control terminal according to a basic structure.

FIG. 8 is a schematic block diagram illustrating the structure of a computer according to at least one example embodiment.

### EXAMPLE EMBODIMENT

### First Example Embodiment

### «Structure of Information Processing System»

Hereinafter, the structure of an information processing system 1 according to a first example embodiment will be explained in detail with reference to the drawings.

The information processing system 1 configures a wireless transmission apparatus 10 on the basis of user selection and configuration information that has been acquired on the basis of position information.

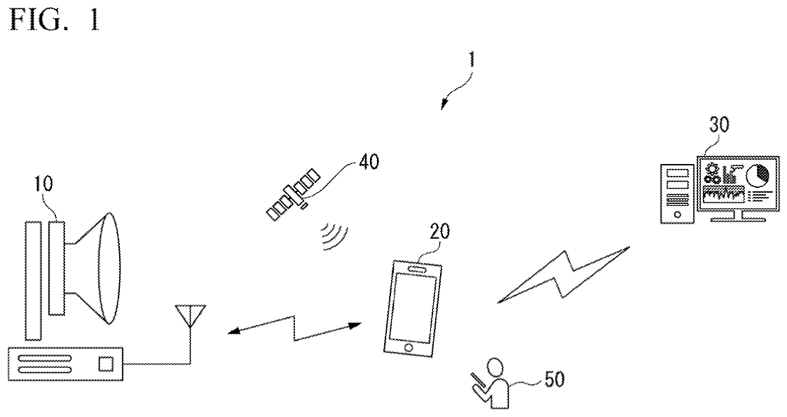

FIG. 1 is a diagram illustrating the structure of the information processing system 1 according to the first example embodiment.

The information processing system 1 is provided with a wireless transmission apparatus 10, a control terminal 20, and a remote management terminal 30.

The wireless transmission apparatus 10 is a communication apparatus that is provided in a base station or the like, and that has functions such as a wireless modulation/demodulation function, a packet switching function, and a protocol processing function. In the example illustrated in FIG. 1, the wireless transmission apparatus 10 is a communication apparatus provided in a base station in a remote location.

The wireless transmission apparatus 10 connects to the control terminal 20 wirelessly.

The control terminal 20 acquires position information of the control terminal 20, receives inputs from a user 50, and configures the wireless transmission apparatus 10.

The control terminal 20 is an example of an information processing apparatus. An example of the control terminal 20 is a mobile terminal. Examples of mobile terminals include notebook computers, tablet terminals, and smartphones. In one example illustrated in FIG. 1, the control terminal 20 is a smartphone carried by the user 50. The control terminal 20 connects to the wireless transmission apparatus 10, the remote management terminal 30, and a satellite 40 wirelessly.

The detailed structure of the control terminal 20 will be explained below.

The remote management terminal 30 receives the position information from the control terminal 20 and identifies configuration information to be transmitted to the control terminal 20. The remote management terminal 30 is an example of a management apparatus. An example of the remote management terminal 30 is a desktop computer. The remote management terminal 30 may be a system provided with a storage apparatus instead of a desktop computer. In the example illustrated in FIG. 1 the remote management terminal 30 is a desktop computer.

The remote management terminal 30 connects to the control terminal 20 wirelessly.

The detailed structure of the remote management terminal 30 will be explained below.

The satellite 40 constitutes a Global Navigation Satellite System (GNSS). The GNSS transmits signals for obtaining position information to the control terminal 20.

The user 50 is a worker who performs installation and maintenance of the wireless transmission apparatus 10.

### «Structure of Control Terminal»

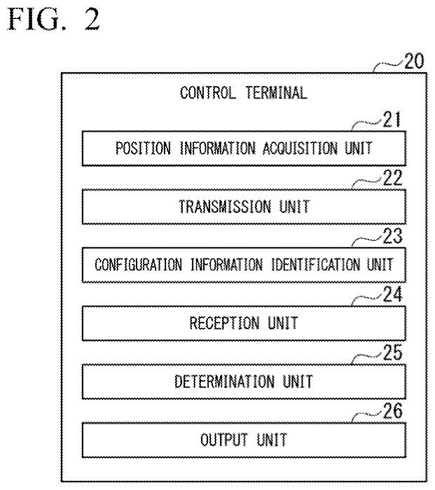

Hereinafter, the structure of the control terminal 20 will be explained. FIG. 2 is a schematic block diagram illustrating the structure of the control terminal 20.

The control terminal 20 is provided with a position information acquisition unit 21, a transmission unit 22, a configuration information identification unit 23, a reception unit 24, a determination unit 25, and an output unit 26.

The position information acquisition unit 21 acquires position information of the control terminal 20 on the basis of signals from the GNSS constituted by the satellite 40. It should be noted that the position information acquisition unit 21 may acquire position information by means of a wireless Local Area Network (LAN), Bluetooth, a radio beacon, or the like instead of the GNSS. The position information acquisition unit 21 is one example of position information acquisition means.

The transmission unit 22 transmits position information acquired by the position information acquisition unit 21 to the remote management terminal 30. Additionally, the transmission unit 22 transmits configuration information determined by the determination unit 25 to the wireless transmission apparatus 10. The transmission unit 22 is an example of transmission means.

The configuration information identification unit 23 identifies one or more items of configuration information corresponding to the position information on the basis of configuration information received from the remote management terminal 30. The configuration information identification unit 23 is an example of configuration information identification means.

In the case in which two or more items of configuration information are identified by the configuration information identification unit 23, the reception unit 24 receives inputs from the user 50, who selects one from among the two or more items of configuration information that have been identified. For example, the user 50 performs inputs for selecting the configuration information on a display apparatus (not illustrated) provided in the control terminal 20. An example of a display apparatus is a touch panel. The reception unit 24 receives the input from the user 50 via the display apparatus. The reception unit 24 is an example of reception means.

The determination unit 25 determines configuration information to be used to configure the wireless transmission apparatus 10 on the basis of the input from the user 50 received by the reception unit 24. Additionally, in the case in which one item of configuration information corresponding to the position information is identified by the configuration information identification unit 23, the determination unit 25 determines the configuration information to be used to configure the wireless transmission apparatus 10 on the basis of the identification by the configuration information identification unit 23.

In other words, in the case in which two or more items of configuration information have been identified by the configuration information identification unit 23, the determination unit 25 determines the configuration information on the basis of the input received by the reception unit 24. In contrast, in the case in which the configuration information identification unit 23 has identified one item of configuration information, the determination unit 25 determines the configuration information on the basis of the configuration information identified by the configuration information identification unit 23.

The determination unit 25 is an example of determination means.

The output unit 26 outputs the configuration information identified by the configuration information identification unit 23 to the display apparatus provided in the control terminal 20. The display apparatus displays the output configuration information to the user 50. The user 50 can perform an input operation on the display apparatus to select one item of configuration information from among the displayed configuration information.

### «Structure of Remote Management Terminal»

Hereinafter, the structure of the remote management terminal 30 will be explained.

The remote management terminal 30 is provided with a storage apparatus (not illustrated). The storage apparatus stores management information in which position information of the control terminal 20 is associated with configuration information relating to configuration of the wireless transmission apparatus 10. An example of the storage apparatus is a hard disk. The user 50 or another user of the information processing system 1 records management information in the storage apparatus provided in the remote management terminal 30 in advance.

Additionally, the remote management terminal 30 receives position information from the control terminal 20. The remote management terminal 30 identifies configuration information by collating the received position information with the management information stored by the storage apparatus. The remote management terminal 30 transmits the identified configuration information to the control terminal 20.

The control terminal 20 receives the transmitted configuration information.

### «Operations of Information Processing System»

Hereinafter, the operations of the information processing system 1 will be explained.

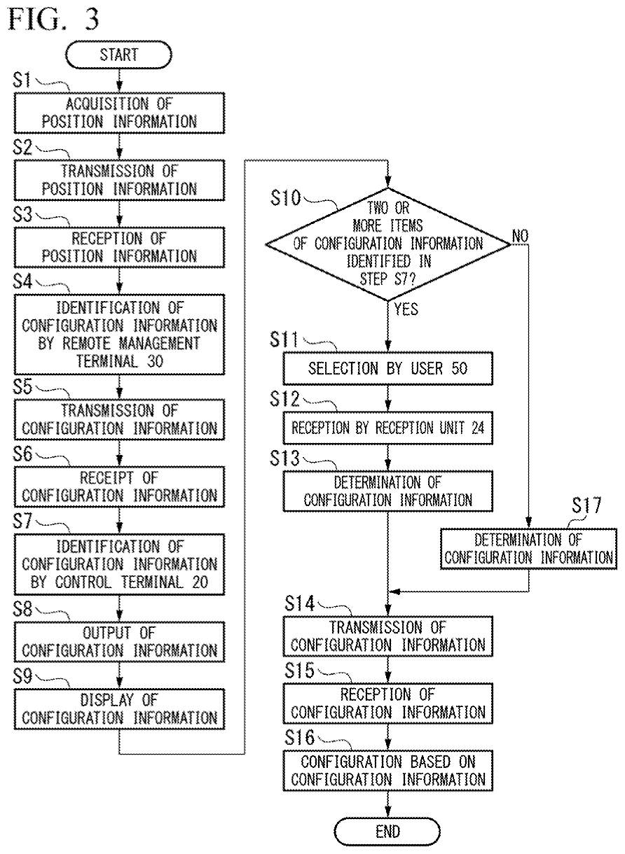

FIG. 3 is a flow chart illustrating the operations of the information processing system 1.

The operations below are operations for the case in which the user 50 installs the wireless transmission apparatus 10 at a remote location.

The position information acquisition unit 21 acquires position information of the control terminal 20 on the basis of signals from the GNSS (step S1). In the case in which position information is not able to be acquired in step S1, the control terminal 20 may display, to the user 50, a message to the effect that the wireless transmission apparatus 10 should be configured manually.

The transmission unit 22 transmits the position information acquired in step S1 to the remote management terminal 30 (step S2).

The remote management terminal 30 receives the position information transmitted in step S2 (step S3).

The remote management terminal 30 identifies configuration information by collating the position information received in step S3 with the management information stored by the storage apparatus provided in the remote management terminal 30 (step S4).

The remote management terminal 30 transmits the identified configuration information to the control terminal 20 (step S5).

The control terminal 20 receives the configuration information transmitted in step S5 (step S6).

The configuration information identification unit 23 identifies configuration information on the basis of the configuration information received in step S6 (step S7). It should be noted that in the case in which the configuration information identification unit 23 cannot identify the configuration information, the control terminal 20 may display, to the user 50, a message to the effect that the wireless transmission apparatus 10 should be configured manually.

The output unit 26 outputs the configuration information identified in step S7 to the display apparatus provided in the control terminal 20 (step S8).

Thereafter, the display apparatus displays the configuration information (step S9).

In the case in which two or more items of configuration information have been identified in step S7 (step S10: YES), the user 50 performs an input operation on the control terminal 20 for selecting one of the items of configuration information (step S11).

The reception unit 24 receives the input in step S11 (step S12).

The determination unit 25 determines configuration information on the basis of the input received in step S12 (step S13). In other words, the determination unit 25 determines that the configuration information selected by the user 50 is the configuration information to be used to configure the wireless transmission apparatus 10.

The transmission unit 22 transmits the configuration information determined in step S13 to the wireless transmission apparatus 10 (step S14).

The wireless transmission apparatus 10 receives the configuration information transmitted in step S14 (step S15).

The wireless transmission apparatus 10 is configured on the basis of the configuration information received in step S15 (step S16).

In contrast, in the case in which one item of configuration information has been identified in step S7 (step S10: NO), the determination unit 25 determines that the configuration information identified in step S7 is the configuration information to be used to configure the wireless transmission apparatus 10 (step S17).

After step S17, the operations from step S14 to step S16 are the same as those described above.

### «Operations and Example Advantageous Effects»

The information processing apparatus according to the present invention is provided with position information acquisition means that acquires position information; configuration information identification means that identifies, from management information in which position information is associated with configuration information for configuring a wireless transmission apparatus 10, one or more items of configuration information corresponding to the position information acquired by the position information acquisition means; reception means that, in a case in which two or more items of the configuration information corresponding to the position information are identified by the configuration information identification means, receives a user input for selecting one of the two or more items of configuration information that have been identified; and determination means that determines the configuration information to be used to configure the wireless transmission apparatus 10 on the basis of the user input that has been received.

The information processing apparatus identifies configuration information corresponding to the acquired position information and receives an input of a selection from the user in the case in which two or more items of configuration information have been identified. Thus, the information processing apparatus can determine the configuration information to be used to configure the wireless transmission apparatus 10 on the basis of the selection input that has been received, thereby allowing configuration errors in the wireless transmission apparatus 10 to be prevented.

Additionally, the determination means in the information processing apparatus determines the configuration information to be used to configure the wireless transmission apparatus 10 on the basis of the identification by the configuration information identification means in the case in which one item of configuration information corresponding to the position information is identified by the configuration information identification means.

The information processing apparatus can determine the configuration information to be used to configure the wireless transmission apparatus 10 on the basis of one item of configuration information that has been identified, and thus can prevent configuration errors in the wireless transmission apparatus 10.

Additionally, the information processing apparatus is further provided with a transmission means that transmits position information to the management apparatus, which stores management information, and the configuration information identification means identifies one or more items of configuration information corresponding to the position information on the basis of the configuration information received from the management apparatus in response to transmission of the position information.

The information processing apparatus can determine the configuration information to be used to configure the wireless transmission apparatus 10 on the basis of the configuration information received from the management apparatus, thereby preventing configuration errors in the wireless transmission apparatus 10.

The information processing method according to the present invention includes acquiring position information; identifying, from management information in which position information is associated with configuration information for configuring a wireless transmission apparatus 10, one or more items of configuration information corresponding to the acquired position information; in a case in which two or more items of the configuration information corresponding to the position information are identified, receiving a user input for selecting one of the two or more items of configuration information that have been identified; and determining the configuration information to be used to configure the wireless transmission apparatus 10 on the basis of the user input that has been received.

With the information processing method, configuration information corresponding to the acquired position information is identified, and an input of a selection is received from the user in the case in which two or more items of configuration information have been identified. Thus, by using the information processing method, the configuration information to be used to configure the wireless transmission apparatus 10 can be determined on the basis of the selection input that has been received, thereby allowing configuration errors in the wireless transmission apparatus 10 to be prevented.

The program according to the present invention makes a computer perform acquiring position information; identifying, from management information in which position information is associated with configuration information for configuring a wireless transmission apparatus 10, one or more items of configuration information corresponding to the acquired position information; in a case in which two or more items of the configuration information corresponding to the position information are identified, receiving a user input for selecting one of the two or more items of configuration information that have been identified; and determining the configuration information to be used to configure the wireless transmission apparatus 10 on the basis of the user input that has been received.

When the program is executed, configuration information corresponding to the acquired position information is identified, and an input of a selection is received from the user in the case in which two or more items of configuration information have been identified. Thus, by executing the program, the configuration information to be used to configure the wireless transmission apparatus 10 can be determined on the basis of the selection input that has been received, thereby allowing configuration errors in the wireless transmission apparatus 10 to be prevented.

### Second Example Embodiment

Hereinafter, an information processing system 1 according to a second example embodiment will be explained.

The structure of the information processing system 1 according to the second example embodiment is a structure that is not provided with a remote management terminal 30 but is provided with an external storage terminal 60. Additionally, the wireless transmission apparatus 10 according to the second example embodiment is provided with a control terminal 20. In other words, the control terminal 20 is provided inside the wireless transmission apparatus 10.

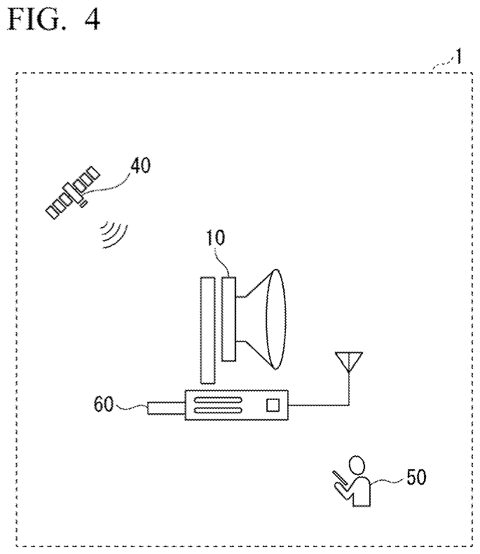

FIG. 4 is a diagram illustrating the structure of the information processing system 1 according to the second example embodiment.

The external storage terminal 60 stores management information. An example of the external storage terminal 60 is a Universal Serial Bus (USB) memory. The external storage terminal 60 is an example of a storage apparatus. The user 50 records management information in the external storage terminal 60 in advance. It should be noted that as mentioned above, the control terminal 20 is provided inside the wireless transmission apparatus 10, and thus a control terminal 20 is not illustrated in FIG. 4.

FIG. 5 is a schematic block diagram illustrating the structure of the control terminal 20 according to the second example embodiment.

The structure of the control terminal 20 according to the second example embodiment is a structure in which a connection unit 27 is provided in addition to the structure of the control terminal 20 according to the first example embodiment.

The connection unit 27 connects to the external storage terminal 60. The transmission unit 22 according to the second example embodiment does not transmit position information to the remote management terminal 30. The configuration information identification unit 23 according to the second example embodiment acquires configuration information by collating the position information acquired by the position information acquisition unit 21 with the management information stored by the external storage terminal 60.

### «Operations of Information Processing System»

Hereinafter, the operations of the information processing system 1 will be explained.

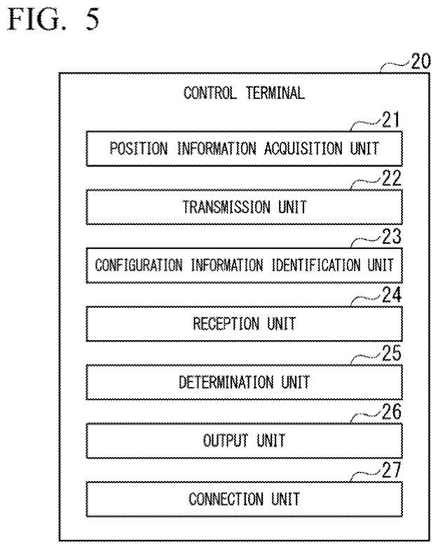

FIG. 6 is a flow chart illustrating the operations of the information processing system 1.

The operation in step S1 is the same as the operation in the information processing system 1 according to the first example embodiment.

After step S1, the configuration information identification unit 23 acquires the configuration information by collating the position information acquired in step S1 with the management information stored by the external storage terminal 60 (step S21).

The operations from step S8 to step S17 are the same as the operations in the information processing system 1 according to the first example embodiment.

### «Operations and Example Advantageous Effects»

The information processing apparatus is further provided with a connection means to which the storage apparatus storing the management information is connected, and the configuration information identification means acquires the configuration information from the storage apparatus.

The information processing apparatus can determine the configuration information to be used to configure the wireless transmission apparatus 10 on the basis of the management information in the storage apparatus that is connected, and thus can prevent configuration errors in the wireless transmission apparatus 10.

### <Basic Structure>

Hereinafter, the information processing system 1 according to a basic structure will be explained.

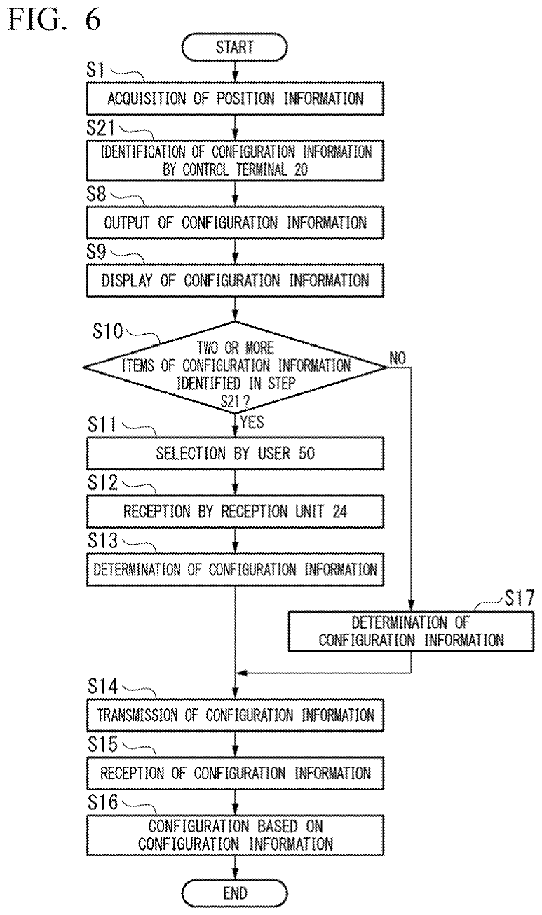

FIG. 7 is a schematic block diagram illustrating the structure of a control terminal 20 in an information processing system 1 according to a basic structure. The control terminal 20 according to the basic structure is provided with a position information acquisition unit 21, a configuration information identification unit 23, a reception unit 24, and a determination unit 25.

The information processing apparatus according to the basic structure is provided with position information acquisition means that acquires position information; configuration information identification means that identifies, from management information in which position information is associated with configuration information for configuring a wireless transmission apparatus 10, one or more items of configuration information corresponding to the position information acquired by the position information acquisition means; reception means that, in a case in which two or more items of the configuration information corresponding to the position information are identified by the configuration information identification means, receives a user input for selecting one of the two or more items of configuration information that have been identified; and determination means that determines the configuration information to be used to configure the wireless transmission apparatus 10 on the basis of the user input that has been received.

The information processing apparatus identifies configuration information corresponding to the acquired position information and receives a selection input from the user in the case in which two or more items of configuration information have been identified. Thus, the information processing apparatus can determine the configuration information to be used to configure the wireless transmission apparatus 10 on the basis of the selection input that has been received, thereby allowing configuration errors in the wireless transmission apparatus 10 to be prevented.

### <Computer Structure>

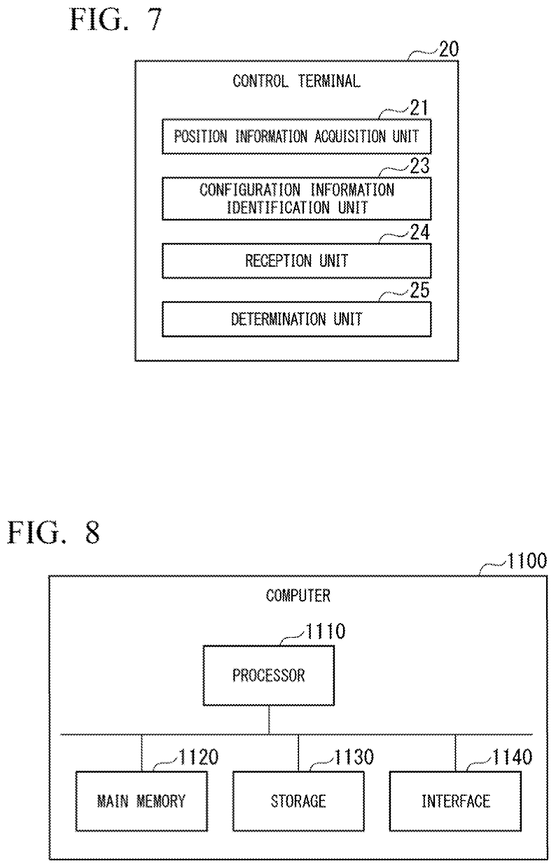

FIG. 8 is a schematic block diagram illustrating the structure of a computer according to at least one example embodiment.

A computer 1100 is provided with a processor 1110, a main memory 1120, a storage 1130, and an interface 1140.

The wireless transmission apparatus 10, the control terminal 20, and the remote management terminal 30 mentioned above are each mounted in the computer 1100. Furthermore, the operations of the abovementioned processing units are stored in the storage 1130 in the form of programs. The processor 1110 reads a program from the storage 1130, loads the program in the main memory 1120, and executes the above-mentioned processes in accordance with the program. Additionally, the processor 1110 secures, in the main memory 1120, a storage area corresponding to the abovementioned storage units in accordance with the program.

The program may be for realizing some of the functions to be performed by the computer 1100. For example, the program may perform functions by combinations with other programs already stored in the storage 1130 or combinations with other programs installed in another apparatus. It should be noted that in another example embodiment, the computer 1100 may be provided with a custom Large-Scale Integrated Circuit (LSI) such as a Programmable Logic Device (PLD) in addition to the abovementioned structures or instead of the abovementioned structures. Examples of PLDs include Programmable Array Logic (PAL), Generic Array Logic (GAL), Complex Programmable Logic Device (CPLD), and Field Programmable Gate Array (FPGA). In this case, some or all of the functions achieved by the processor 1110 may be realized by these integrated circuits.

Examples of the storage 1130 include magnetic disks, magneto-optic disks, and semiconductor memories. The storage 1130 may be internal media directly connected to a bus in the computer 1100, or may be external media connected to the computer by means of the interface 1140 or by a communication line. Additionally, in the case in which this program is distributed to the computer 1100 by a communication line, the computer 1100 that has received the distribution may load the program in the main memory 1120 and execute the above-mentioned processes. In at least one example embodiment, the storage 1130 is a tangible, non-transitory storage medium.

Additionally, the program may realize some of the aforementioned functions. Furthermore, the program may be a so-called difference file (difference program) that realizes the aforementioned functions in combination with another program already stored in the storage 1130.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

What is claimed is:

1. An information processing apparatus comprising:
a memory configured to store instructions, and
a processor configured to execute the instructions to
acquire position information;
identify, from management information in which position information is associated with configuration information for configuring a wireless transmission apparatus, one or more items of configuration information corresponding to the acquired position information;
in a case in which two or more items of the configuration information corresponding to the position information are identified, receive a user input for selecting one of the two or more items of configuration information that have been identified; and
determine the configuration information to be used to configure the wireless transmission apparatus on the basis of the user input that has been received.

2. The information processing apparatus according to claim 1, wherein in a case in which one item of the configuration information corresponding to the position information is identified, the processor determines the configuration information to be used to configure the wireless transmission apparatus on the basis of identification.

3. The information processing apparatus according to claim 1, wherein the processor further transmits the position information to a management apparatus that stores the management information, and
the one or more items of configuration information corresponding to the position information are identified on the basis of the configuration information received from the management apparatus in response to transmission of the position information.

4. The information processing apparatus according to claim 1, wherein the processor connects to a storage apparatus that stores the management information and acquires the configuration information from the storage apparatus.

5. An information processing method comprising:
acquiring position information;
identifying, from management information in which position information is associated with configuration information for configuring a wireless transmission apparatus, one or more items of configuration information corresponding to the acquired position information;
in a case in which two or more items of the configuration information corresponding to the position information are identified, receiving a user input for selecting one of the two or more items of configuration information that have been identified; and
determining the configuration information to be used to configure the wireless transmission apparatus on the basis of the user input that has been received.

6. A non-transitory computer-readable recording medium recording a program for making a computer perform:
acquiring position information;
identifying, from management information in which position information is associated with configuration information for configuring a wireless transmission apparatus, one or more items of configuration information corresponding to the acquired position information;
in a case in which two or more items of the configuration information corresponding to the position information are identified, receiving a user input for selecting one of the two or more items of configuration information that have been identified; and
determining the configuration information to be used to configure the wireless transmission apparatus on the basis of the user input that has been received.
